(19) United States
(12) Patent Application Publication
(10) Pub. No.: US 2011/0240721 A1
(43) Pub. Date: Oct. 6, 2011

(54) MICROWAVE-ACTIVATABLE ADHESIVE COMPOSITIONS FOR PRODUCING FOLDING-CARTON BLANKS

(75) Inventors: Dieter Urban, Speyer (DE); Karl-Heinz Schumacher, Neustadt (DE); Stefan Kirsch, Shanghai (CN); Uta Holzenkamp, Lambsheim (DE)

(73) Assignee: BASF SE, Ludwigshafen (DE)

(21) Appl. No.: 13/041,755

(22) Filed: Mar. 7, 2011

Related U.S. Application Data
(60) Provisional application No. 61/311,408, filed on Mar. 8, 2010.

(51) Int. Cl. B31B 1/62; B65D 5/62

(52) U.S. Cl. 229/5.81; 493/128

(57) ABSTRACT

Described is the use of a microwave-activatable adhesive composition for producing folding-carton blanks for the microwave-activated production of folding cartons. The adhesive composition preferably at less than or equal to 25° C. has an Ig G′ value of greater than or equal to 6 and at greater than or equal to 120° C. has an Ig G′ value of less than or equal to 4, and comprises at least one polymer having a glass transition temperature of greater than 30° C., the folding-carton blanks with adhesive composition applied thereto being blocking-resistant at 25° C. prior to microwave activation.

This patent application claims the benefit of pending U.S. provisional patent application Ser. No. 61/311,408 filed Mar. 8, 2010, incorporated in its entirety herein by reference.

The invention relates to the use of microwave-activatable adhesive compositions for producing folding-carton blanks for the microwave-activated production of folding cartons, and also to a method for producing folding cartons using the folding-carton blanks.

Folding-carton blanks are industrially pre-produced blanks which are supplied space-savingly in the flat, collapsed state from the manufacturer to the processing enterprises, where they are erected to form cartons and are filled and sealed. In many cases, the erected portions opposite one another in each case are joined to one another by adhesive bonding and/or the cartons after filling are sealed by adhesive bonding. Conventionally, folding-carton blanks intended for adhesive bonding are supplied unglued, i.e., without applied adhesive, to the processing enterprise, in the form, for example, of carton type E according to the classification system of the European Carton Makers' Association. In that case, immediately prior to their entry into the erecting apparatus, the blanks are provided with a hotmelt adhesive and, following erection, are bonded adhesively. There is a risk here of the erecting machinery being compromised by glue deposits on the nozzles and tools, and, even when adhesive positioning is precise, of there possibly being unwanted, visible glue traces on the finished packaging. The desire, therefore, is for a technology which makes it unnecessary to apply adhesive at the processing enterprise immediately prior to folding-carton erection.

DE 3246325 describes a method for producing folding cartons where a dispersion-based varnish is applied to blanks and adhesive bonding is effected by exposure to ultrasound. WO 2004/076578 describes a reactivatable adhesive which is reactivated by exposure to radiative energy having a wavelength of 400 nm to 100000 nm. The radiative energy is generated more particularly by NIR radiation, e.g., by a halogen-tungsten lamp, and the adhesive comprises an NIR absorber ingredient. The unspecific, undirected use of relatively high-energy NIR radiation may result in unwanted, extensive heating even of parts of the packaging that are not intended for adhesive bonding, or of the contents for packing, and this compromises the possibilities for filling of the packaging with heat-sensitive or radiation-sensitive contents before or immediately after irradiation, and, furthermore, consumes more energy than is needed for actual bonding.

It was an object of the present invention to provide, for folding-carton manufacture, a technology which is both energy-efficient and time-efficient and which makes it possible to do away with application of adhesive at the processing enterprise immediately prior to folding-carton erection. The technology ought ideally further to allow the adhesive bonding, or sealing effected by adhesive bonding, of folding cartons which are already filled with heat-sensitive or radiation-sensitive contents or which are to be filled with such contents immediately following the adhesive-bonding operation.

The invention provides for use of a microwave-activatable adhesive composition for producing folding-carton blanks for the microwave-activated production of folding cartons.

The invention also provides a method for producing folding cartons, in which
(1) flat folding-carton blanks are provided,
(2) a microwave-activatable adhesive composition is applied to parts at least of the flat folding-carton blanks,
(3) the flat folding-carton blanks are erected to form a folding carton, and
(4) before, during or after the erection of the folding-carton blanks, the adhesive composition is activated by microwave radiation, and adhesive bonding of the folding cartons is effected thereby.

Microwave radiation for the purposes of the invention is electromagnetic radiation with a wavelength of 1 mm to 1 m.

The term “adhesive composition” encompasses the active adhesive-bonding ingredients and any adjuvants and solvents present.

Unless indicated otherwise, physical parameters and properties relate to conditions at room temperature (25° C.) and relative atmospheric humidity typical of this sector (30-90%).

The adhesive composition has a temperature-dependent adhesiveness profile. At room temperature (25° C.), the adhesiveness of the composition is low or zero. At temperatures above room temperature, the composition is adhesive.

Preferably the adhesive composition at less than or equal to 25° C. has an Ig G′ value of greater than or equal to 6.0, preferably of 6.0 to 8.0, and at temperatures of greater than or equal to 120° C. has an Ig G′ value of less than or equal to 4.0, preferably of 2.5 to 3.9, as measured by means of a deformation-controlled rheometer with parallel-plate geometry (diameter 8 mm; sample thickness 0.9-1.2 mm) and torsion-rectangular geometry (sample width 6 mm; sample length 21 mm, sample thickness 0.9-1.2 mm). The parameter measured is the dynamic shear modulus G′ at a measurement frequency of 1 Hz with the torsion-rectangular geometry at 25° C. and with the parallel-plate geometry at 120° C. For the measurements, films are cast from the adhesives and are dried to constant weight. The Ig G′ values of the invention can be adjusted through the monomer composition of the adhesive polymers or through addition of plasticizer. Where the monomer composition of the polymers does not itself give the adhesive composition the Ig G′ values, the Ig G′ values can be adjusted in accordance with the invention by addition of the plasticizers described in more detail below.

The folding-carton blanks with adhesive composition applied thereto are preferably blocking-resistant at 25° C. prior to microwave activation. Blocking-resistant for the purposes of the specification means that, when an individual blank is lifted from a stack of two or more blanks, no further blank adheres. In the stack there may be a pressure of up to 2 g/mm².

The adhesive composition may be (before application to the blanks and drying where appropriate) a meltable solid composition, a polymer solution or a polymer dispersion. Aqueous polymer solutions and aqueous polymer dispersions are preferred. Included preferably is at least one polymer which has a glass transition temperature Tg of greater than 30° C., preferably of greater than 35° C. or, more preferably, of greater than 40° C. The glass transition temperature can be determined by typical methods such as Differential Scanning calorimetry (see, for example, ASTM 3418/82, midpoint temperature). In the case of aqueous polymer dispersions, the dispersion preferably includes solids contents of 15% to 75% by weight. In one embodiment the adhesive composition comprises at least 40% by weight, preferably from 40% to 75% by weight of dispersed polymer.

By polymers in the sense of the invention are meant both homopolymers of a single monomer and also copolymers of two or more different monomers. In the text below, the designation (meth)acrylate and similar designations are used as an abbreviated notation for “acrylate or methacrylate”.

Polymers preferably used in the adhesive composition are polyurethanes or polymers obtainable by free-radical polymerization of ethylenically unsaturated compounds (monomers). The polymer is composed preferably to an extent of at least 40% or at least 60%, or at least 80%, more preferably at least 90%, by weight of what are called principal monomers. The principal monomers are preferably selected from C₁-C₂₀ alkyl (meth)acrylates, vinyl esters of carboxylic acids comprising up to 20 C atoms, vinylaromatics having up to 20 C atoms, ethylenically unsaturated nitriles, vinyl halides, vinyl ethers of alcohols comprising from 1 to 10 C atoms, aliphatic hydrocarbons having 2 to 8 C atoms and one or two double bonds, or mixtures of these monomers.

Preference is also given to vinyl acetate polymers and (meth)acrylate polymers. The vinyl acetate polymers are formed from at least one vinyl acetate monomer, which may be copolymerized with other monomers, an example being ethylene/vinyl acetate copolymer. The (meth)acrylate polymers are formed from at least one (meth)acrylate monomer, which may be copolymerized with further monomers.

Suitable monomers are, for example, (meth)acrylic acid alkyl esters with a C₁-C₁₀ alkyl radical, such as methyl methacrylate, methyl acrylate, n-butyl acrylate, ethyl acrylate, and 2-ethylhexyl acrylate. Also suitable in particular are mixtures of the (meth)acrylic acid alkyl esters. Vinyl esters of carboxylic acids having 1 to 20 C atoms are, for example vinyl laurate, vinyl stearate, vinyl propionate, Versatic acid vinyl esters, and vinyl acetate. Vinylaromatic compounds contemplated include vinyltoluene, a- and p-methylstyrene, a-butylstyrene, 4-n-butylstyrene, 4-n-decylstyrene, and—preferably—styrene. Examples of nitriles are acrylonitrile and methacrylonitrile. The vinyl halides are chlorine-, fluorine- or bromine-substituted, ethylenically unsaturated compounds, preferable vinyl chloride and vinylidene chloride. Examples of vinyl ethers include vinyl methyl ether or vinyl isobutyl ether. Those preferred are vinyl ethers of alcohols comprising 1 to 4 C atoms. Suitable hydrocarbons having 4 to 8 C atoms and two olefinic double bonds are, for example, butadiene, isoprene, and chloroprene. Hydrocarbons having 2 to 4 C atoms are, for example, ethylene, propylene or butene.

Preferred principal monomers are C₁ to C₁₀ alkyl acrylates and C₁ to C₁₀ alkyl methacrylates, more particularly C₁ to C₈ alkyl acrylates and methacrylates, and vinylaromatics, more particularly styrene, and mixtures thereof. Especially preferred are methyl acrylate, methyl methacrylate, ethyl acrylate, n-butyl acrylate, n-hexyl acrylate, octyl acrylate, and 2-ethylhexyl acrylate, styrene, and mixtures of these monomers.

Besides the principal monomers the polymer may comprise further monomers, examples being monomers having carboxylic, sulfonic or phosphonic acid groups. Carboxylic acid groups are preferred. Examples include acrylic acid, methacrylic acid, itaconic acid, maleic acid or fumaric acid. The amount of acid monomers in the polymer can in the case of aqueous dispersions be, for example, 0% to 15% by weight, more particularly 0.05% to 5% by weight, based on the polymer. In the case of aqueous solutions, the amount of acid monomers can be up to 40% by weight, e.g., from 25% to 40% by weight, based on the polymer. The acid groups may be present in the form of their salts. Further monomers are, for example, also monomers comprising hydroxyl groups, more particularly C₁-C₁₀ hydroxyalkyl (meth)acrylates, or (meth)acrylamide. Other monomers that may be recited include phenyloxyethylglycol mono(meth)acrylate, glycidyl (meth)acrylate, and aminoalkyl (meth)acrylates such as, for example, 2-aminoethyl (meth)acrylate. Alkyl groups have preferably from 1 to 20 C atoms. Crosslinking monomers may also be recited as further monomers. The further monomers are used generally in minor amounts, their total proportion being preferably below 10% by weight, more particularly below 5% by weight.

Preferred copolymers are composed to an extent of at least 10% or at least 20%, or at least 40%, more preferably at least 60%, by weight of at least one first monomer, and to an extent of more than 3% and up to 40% by weight of at least one second monomer. The first monomer is selected from alkyl (meth)acrylates and vinylaromatics. The alkyl (meth)acrylate monomers are preferably selected from C₁-C₂₀ alkyl (meth)acrylates, more particularly C₁ to C₁₀ alkyl acrylates and C₁ to C₁₀ alkyl methacrylates, or C₁ to C₈ alkyl (meth)acrylates. Suitable monomers are, for example, methyl methacrylate, methyl acrylate, n-butyl acrylate, ethyl acrylate, n-hexyl acrylate, octyl acrylate, and 2-ethylhexyl acrylate. Also suitable in particular are mixtures of the (meth)acrylic acid alkyl esters. The vinylaromatics are preferably selected from vinylaromatics having up to 20 C atoms. Vinylaromatics contemplated include vinyltoluene, a- and p-methylstyrene, a-butylstyrene, 4-n-butylstyrene, 4-n-decylstyrene, and—preferably—styrene. In one embodiment the copolymers of the invention comprise styrene in amounts from 10% to 60% by weight, preferably 20-50% by weight.

The second monomer is selected from ethylenically unsaturated monomers with acid groups, hydroxyalkyl acrylates and hydroxyalkyl methacrylates. Monomers with acid groups are more particularly ethylenically unsaturated compounds which have at least one carboxylic, sulfonic or phosphonic acid group. Carboxylic acid groups are preferred. Examples include acrylic acid, methacrylic acid, itaconic acid, maleic acid or fumaric acid. The acid groups may be present in the form of their salts. Preferred hydroxyalkyl (meth)acrylates are the C₂ to C₁₂ hydroxyalkyl (meth)acrylates, and more particularly the C₂ to C₆ or the C₂ to C₄ hydroxyalkyl (meth)acrylates. Especially preferred are hydroxyethyl acrylate, hydroxyethyl methacrylate, hydroxypropyl acrylate, hydroxypropyl methacrylate, hydroxybutyl acrylate or hydroxybutyl methacrylate. The amount of acid monomers and hydroxyl monomers in the copolymer can be, for example, 4% to 15% by weight in the case of aqueous dispersions, or in the case of aqueous solutions, up to 40%, e.g., 24% to 40%, by weight, based on the polymer.

More particularly the polymer is composed to an extent of at least 60%, more preferably at least 80%, and very preferably at least 90%, or at least 95%, by weight of C₁ to C₂₀ alkyl (meth)acrylates or of C₁ to C₂₀ alkyl (meth)acrylates in combination with styrene.

The proportion of the monomers relative to one another is preferably set such that the glass transition temperature of the polymer is greater than 30° C., or greater than 35° C. or greater than 40° C.

The free-radically polymerized polymers may be prepared by conventional emulsion polymerization. In emulsion polymerization, ionic and/or nonionic emulsifiers and/or protective colloids and/or stabilizers, as surface-active substances, and also suitable initiators and, if desired, molecular-weight regulators are used. The emulsion polymerization takes place in general at 30 to 130° C., preferably at 50 to 90° C. The polymerization medium may be composed either of water alone, or of mixtures of water and water-miscible liquids such as methanol. It is preferred to use just water. In the polymerization it is possible to include a polymer seed in the initial charge for the purpose, for example, of more effectively setting the particle size. The emulsion polymerization affords aqueous dispersions of the polymer generally with solids contents of 15% to 75% by weight, preferably of 40% to 75% by weight. Dispersions having a very high solids content are preferred. In one embodiment the dispersion or adhesive composition comprises at least 60% by weight of dispersed polymer. In order to be able to obtain solids contents >60% by weight, the particle size set ought to be bimodal or polymodal, since otherwise the viscosity becomes too high and the dispersion can no longer be managed. Generating a new generation of particles can be accomplished by adding seed, by adding excess amounts of emulsifier, or by adding miniemulsions, for example. Generating one or more new particle generations can take place at any desired point in time. Said point in time is guided by the target particle-size distribution for a low viscosity. The polymer thus prepared is used in the form of its aqueous dispersion. The size distribution of the dispersion particles may be monomodal, bimodal or multimodal. In the case of monomodal particle-size distribution, the average particle size of the polymer particles dispersed in the aqueous dispersion is preferably less than 400 nm, more particularly less than 200 nm. With particular preference the average particle size is between 140 and 200 nm. By average particle size here is meant the d₅₀ value of the particle-size distribution, i.e., 50% by weight of the total mass of all particles have a particle diameter smaller than the d₅₀ value. The particle-size distribution can be determined in a known way using the analytical ultracentrifuge (W. Mächtle, Makromolekulare Chemie 185 (1984), pages 1025-1039). In the case of bimodal or multimodal particle-size distribution, the particle size may be up to 1000 nm. The pH of the polymer dispersion is adjusted preferably to a pH of more than 4.5, more particularly to a pH of between 5 and 8.

Other preferred polymers in the adhesive composition are polyurethanes, ethylene/vinyl acetate copolymers, polyamide resins, saturated polyesters, polyolefins, styrene/butadiene block copolymers, styrene/isoprene block copolymers, polyimides, PVC, and polyvinylpyrrolidone.

Polyurethanes are used preferably in the form of aqueous polyurethane dispersions (PUD). Suitable polyurethanes are obtainable in principle through reaction of at least one polyisocyanate with at least one compound which has at least two groups that are reactive toward isocyanate groups. The polyurethane dispersion (PUD) of the invention preferably comprises at least one polyurethane which comprises in copolymerized form at least one polyisocyanate and at least one polymeric polyol. Suitable polymeric polyols are preferably selected from polyester diols, polyether diols, polycarbonate diols, and mixtures thereof. The polymeric polyol preferably has a number-average molecular weight in the range from about 500 to 5000 g/mol. Polymeric diols are preferred. The polyurethane dispersion (PUD) of the invention preferably comprises at least one polyurethane which comprises in copolymerized form at least one polyisocyanate and one diol component, of which a) 10-100 mol %, based on the total amount of the diols, have a molecular weight of 500 to 5000 g/mol and b) 0-90 mol %, based on the total amount of the diols, have a molecular weight of 60 to 500 g/mol.

The polyurethane is composed preferably to an extent of at least 40%, more preferably at least 60%, and very preferably at least 80%, by weight, based on the total weight of the monomers used to prepare the polyurethane, of at least one diisocyanate and at least one polyether diol and/or polyester diol. Preferably at least 95 mol % of the diols are polyester diols and/or polytetrahydrofuran. With particular preference, polyester diols and/or polytetrahydrofuran are used exclusively as diols. Suitable other synthesis components to make up the composition to 100% by weight, are, for example, polyisocyanates having at least three NCO groups, and compounds other than the polymeric polyols that have at least two groups that are reactive toward isocyanate groups. These include, for example, diols; diamines; polymers different from polymeric polyols and having at least two active hydrogen atoms per molecule; compounds which have two active hydrogen atoms and at least one ionogenic or ionic group per molecule; and mixtures thereof.

Diisocyanates are, for example, those of the formula X(NCO)₂, where X is an aliphatic hydrocarbon radical having 4 to 15 C atoms, a cycloaliphatic or aromatic hydrocarbon radical having 6 to 15 C atoms, or an araliphatic hydrocarbon radical having 7 to 15 C atoms. Examples of diisocyanates of this kind are tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI), such as the trans/trans, the cis/cis, and the cis/trans isomer, and also mixtures of these compounds.

As polyester diols it is preferred to use those obtained by reaction of dihydric alcohols with dibasic carboxylic acids. In place of the free polycarboxylic acids it is also possible to use the corresponding polycarboxylic anhydrides or corresponding polycarboxylic esters of lower alcohols or mixtures thereof to prepare the polyester polyols. The polycarboxylic acids may be aliphatic, cycloaliphatic, araliphatic, aromatic or heterocyclic and may if desired be substituted, by halogen atoms for example, and/or saturated. Examples of such that may be cited include the following: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid and dimeric fatty acids. Preference is given to dicarboxylic acids of the general formula HOOC—(CH₂)_{y}—COOH, where y is a number from 1 to 20, preferably an even number from 2 to 20, examples being succinic acid, adipic acid, sebacic acid, and dodecanedicarboxylic acid. Examples of polyhydric alcohols contemplated include ethylene glycol, propane-1,2-diol, propane-1,3-diol, butane-1,3-diol, butene-1,4-diol, butyne-1,4-diol, pentane-1,5-diol, neopentylglycol, bis(hydroxymethyl)cyclohexanes such as 1,4-bis(hydroxymethyl)cyclohexane, 2-methylpropane-1,3-diol, methylpentanediols, and also diethylene glycol, triethylene glycol, tetraethylene glycol, polyethylene glycol, dipropylene glycol, polypropylene glycol, dibutylene glycol, and polybutylene glycols. Preference is given to alcohols of the general formula HO—(CH₂)ₓ—OH, where x is a number from 1 to 20, preferably an even number from 2 to 20. Examples of such are ethylene glycol, butane-1,4-diol, hexane-1,6-diol, octane-1,8-diol, and dodecane-1,12-diol. Additionally preferred is neopentylglycol. Suitable polyester diols also include those that are lactone-based. Lactones contemplated include, preferably, those deriving from compounds of the general formula HO—(CH₂)_{z}—COOH, where z is a number from 1 to 20 and one H atom of a methylene unit may also be substituted by a C₁ to C₄ alkyl radical. Examples are ε-caprolactone, β-propiolactone, γ-butyrolactone and/or methyl-γ-caprolactone, and mixtures thereof.

Suitable polyether diols are, in particular, obtainable by polymerization of ethylene oxide, propylene oxide, butylene oxide, tetrahydrofuran, styrene oxide or epichlorohydrin with itself, in the presence of BF₃, for example, or by addition reaction of these compounds, optionally in a mixture or in succession, with starting components containing reactive hydrogen atoms, such as alcohols or amines, e.g., water, ethylene glycol, propane-1,2-diol, propane-1,3-diol, 2,2-bis(4-hydroxyphenyl)propane or aniline. Particularly preferred are polyether diols with a molecular weight of 500 to 5000, and especially 600 to 4500. One particularly preferred polyether diol is polytetrahydrofuran.

Suitable compounds are also α,ω-diamino polyethers, which can be prepared by aminating polyalkylene oxides with ammonia.

Besides the polymeric polyols it is also possible as diols to use low molecular diols having a molecular weight of about 60 to 500, preferably of 62 to 200 g/mol, examples being short-chain alkanediols, in which case preference is given to the unbranched diols having 2 to 12 C atoms and an even number of C atoms, and also pentane-1,5-diol and neopentylglycol. Examples of diols contemplated include ethylene glycol, propane-1,2-diol, propane-1,3-diol, butane-1,3-diol, butene-1,4-diol, butyne-1,4-diol, pentane-1,5-diol, neopentylglycol, bis(hydroxymethyl)cyclohexanes such as 1,4-bis(hydroxymethyl)cyclohexane, 2-methylpropane-1,3-diol, methylpentanediols, and also diethylene glycol, triethylene glycol, tetraethylene glycol, polyethylene glycol, dipropylene glycol, polypropylene glycol, dibutylene glycol, and polybutylene glycols. Preference is given to alcohols of the general formula HO—(CH₂)ₓ—OH, where x is a number from 1 to 20, preferably an even number from 2 to 20. Examples of such are ethylene glycol, butane-1,4-diol, hexane-1,6-diol, octane-1,8-diol, and dodecane-1,12-diol. Additionally preferred is neopentylglycol.

In order to improve the dispersibility of the polyurethanes in water, the polyurethanes preferably comprise additional monomers, which carry at least one isocyanate group or at least one group which is reactive toward isocyanate groups, and, furthermore, at least one hydrophilic group or a group which can be converted into a hydrophilic group, as a synthesis component. In the text below, the term “hydrophilic groups or potentially hydrophilic groups” is abbreviated to “(potentially) hydrophilic groups”. The (potentially) hydrophilic groups may be nonionic or, preferably, (potentially) ionic hydrophilic groups.

Nonionic hydrophilic groups contemplated include more particularly polyethylene glycol ethers comprising preferably 5 to 100, more preferably 10 to 80, repeating ethylene oxide units. The amount of the polyethylene oxide units is generally 0% to 10%, preferably 0% to 6%, by weight, based on the amount by weight of all the monomers. Preferred monomers having nonionic hydrophilic groups are polyethylene oxide diols with at least 20% by weight of ethylene oxide, polyethylene oxide monools, and also the reaction products of a polyethylene glycol and a diisocyanate that carry a terminally etherified polyethylene glycol radical.

Ionic hydrophilic groups are, in particular, anionic groups such as the sulfonate, the carboxylate, and the phosphate group in the form of their alkali metal salts or ammonium salts, and also cationic groups such as ammonium groups, more particularly protonated tertiary amino groups or quaternary ammonium groups. Potentially ionic hydrophilic groups are, in particular, those which can be converted by simple neutralization, hydrolysis or quaternization reactions into the above-mentioned ionic hydrophilic groups, in other words, for example, carboxylic acid groups or tertiary amino groups. Examples of (potentially) cationic monomers are, in particular, monomers with tertiary amino groups: tris(hydroxyalkyl)amines, N,N′-bis(hydroxyalkyl)alkylamines, N-hydroxyalkyldialkylamines, tris(aminoalkyl)amines, N,N′-bis(aminoalkyl)alkylamines, N-aminoalkyldialkylamines, the alkyl radicals of these tertiary amines being composed independently of one another of 1 to 6 C atoms, and also polyethers containing tertiary nitrogen atoms and having preferably two terminal hydroxyl groups. Monomers with (potentially) anionic groups that are contemplated include, customarily, aliphatic, cycloaliphatic, araliphatic or aromatic carboxylic acids and sulfonic acids which carry at least one alcoholic hydroxyl group or at least one primary or secondary amino group. Preference is given to dihydroxyalkylcarboxylic acids, especially those having 3 to 10 carbon atoms, an example being dimethylolpropionic acid (DMPA). Additionally suitable are corresponding dihydroxysulfonic acids and dihydroxyphosphonic acids such as 2,3-dihydroxypropanephosphonic acid. Also suitable are diaminocarboxylic acids and diaminosulfonic acids, e.g., N-(2-aminoethyl)-2-aminoethanecarboxylic acid, and also N-(2-aminoethyl)-2-aminoethanesulfonic acid, and the corresponding alkali metal salts, in which case Na is a particularly preferred counterion.

Preferred polyurethanes are composed of aromatic or aliphatic diisocyanates, of polyether diols or, preferably, polyester diols, and also of diols or diamines which carry sulfonate or carboxylate groups.

Preferred polymers of the adhesive composition are acrylate or methacrylate polymers which apart from acrylic ester and/or methacrylic ester monomers are formed from monomers with acid groups. The monomers with acid groups are present preferably to an extent of more than 3% and less than 35% by weight, based on the total amount of monomers. Examples of monomers with acid groups include monomers with carboxylic, sulfonic or phosphonic acid groups. Carboxylic acid groups are preferred. Examples include acrylic acid, methacrylic acid, itaconic acid, maleic acid or fumaric acid. The acid groups may be present in the form of their salts. In one particularly preferred embodiment the acrylate copolymers of the invention comprise styrene in amounts from 10% to 60% by weight, preferably 20-50% by weight.

The adhesive composition preferably comprises at least one microwave-radiation absorber. This component is preferably itself not adhesive or tacky, and is present preferably in an amount of 2% to 30%, more particularly of 5% to 15%, by weight, based on the overall composition.

A component is a microwave-radiation absorber in the sense of the invention if on irradiation with microwaves it absorbs energy, heats up in doing so, and emits the absorbed energy to the surroundings, in the form of heat. The microwave-radiation absorber is selected, for example, from the group consisting of carbon black, graphite or organic color pigments, and mixtures thereof.

The adhesive composition preferably comprises at least one plasticizer. The plasticizers are present preferably in an amount of 5% to 50%, more particular of 5% to 35%, by weight, based on the overall composition. Examples of plasticizers are phthalic esters, trimellitic esters, acyclic dicarboxylic esters, polymeric plasticizers, phosphoric esters, fatty acid esters, hydroxycarboxylic esters, epoxy plasticizers, polyamide plasticizers, and polyalkylene glycols. Phthalic esters and trimellitic esters are, for example, the esters of phthalic acid, isophthalic acid or mellitic acid, respectively, with C1-C10 alkanols, e.g., di-n-octyl phthalate, di-n-nonyl phthalate, di-n-decyl phthalate, diisodecyl phthalate, di-n-octyl isophthalate, di-n-nonyl isophthalate, diisononyl phthalate, di-n-decyl isophthalate, di(2-ethylhexyl) phthalate, di-n-butyl phthalate, diisobutyl phthalate, dicyclohexyl phthalate, dimethyl phthalate, diethyl phthalate, and tris(2-ethylhexyl) trimellitate. Acyclic dicarboxylic esters are, for example, diesters of dicarboxylic acids with alkanols, more particularly the diesters of C₄ to C₁₀ dicarboxylic acids with C₁ to C₁₀ alkanols, examples being the diesters of adipic acid, decanedioic acid, glutaric acid, and succinic acid, e.g., dimethyl adipate, diethyl adipate, di-n-butyl adipate, diisobutyl adipate, dimethyl glutarate, diethyl glutarate, di-n-butyl glutarate, diisobutyl glutarate, dimethyl succinate, diethyl succinate, di-n-butyl succinate, and diisobutyl succinate, and also mixtures of the aforementioned compounds. Polymeric plasticizers are, for example, the polyesters of dicarboxylic acids and alkanediols, more particularly of C₄ to C₁₀ dicarboxylic acids and C₂ to C₁₀ diols with molecular weights Mr of 1800 to 13000, e.g., polyesters of adipic acid, decanedioic acid, azelaic acid or phthalic acid with diols such as butane-1,3-diol, propane-1,2-diol, butane-1,4-diol, hexane-1,6-diol, and others. Phosphoric esters are, for example, phosphoric acid compounds esterified at least once with alkanol, examples being C₁-C₁₀ alkyl di-C₆-C₁₄ aryl phosphates. Examples are isodecyl diphenyl phosphate, tricresyl phosphate, triphenyl phosphate, diphenyl cresyl phosphate, diphenyl acetyl phosphate, tris(2-ethylhexyl) phosphate, and tris(2-butoxyethyl) phosphate. Hydroxycarboxylic esters are, for example, citric esters, such as tributyl O-acetyl citrate, for example, and corresponding esters of tartaric acid and of lactic acid. Polyamide plasticizers are, for example, benzenesulfonamides and methylbenzenesulfonamides.

Particularly preferred plasticizers are polyalkylene glycols, more particularly polyethylene glycol, polypropylene glycol, polyethylene glycol-polypropylene glycol copolymers, more particularly the block copolymers, and also polypropylene glycols etherified with two different alcohols. Suitable polyalkylene glycols are more particularly those having a molecular weight of 100 to 2000. Examples of suitable plasticizers include polyethylene glycols which are available commercially under the brand name Puriol® E. Preferably included is at least one polyethylene glycol, more particularly having a molecular weight of 100 to 2000. The polyethylene glycols are present preferably in an amount of 5% to 35%, more particularly of 10% to 30%, by weight, based on the overall composition.

The adhesive composition may comprise a tackifier (tackifying resins). Tackifiers are known, for example, from Adhesives Age, July 1987, pages 19-23, or Polym. Mater. Sci. Eng. 61 (1989), pages 588-592. Tackifiers are, for example, natural resins, such as rosins and their derivatives formed by disproportionation or isomerization, polymerization, dimerization or hydrogenation. These derivatives may be present in their salt form (with, for example, monovalent or polyvalent counterions (cations)) or, preferably, in their esterified form. Alcohols used for the esterification may be monohydric or polyhydric. Examples are methanol, ethanediol, diethylene glycol, triethylene glycol, 1,2,3-propanethiol, and pentaerythritol. Also employed are hydrocarbon resins, examples being coumarone-indene resins, polyterpene resins, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, a-methylstyrene, and vinyltoluene. Also used as tackifiers are polyacrylates which have a low molar weight. These polyacrylates preferably have a weight-average molecular weight M_{w} of below 30000. The polyacrylates are preferably composed to an extent of at least 60%, more particularly at least 80%, by weight of C₁-C₈ alkyl (meth)acrylates. Preferred tackifiers are natural or chemically modified rosins. Rosins are composed predominantly of abietic acid or derivatives of abietic acid. The tackifiers can be added in a simple way to the polymer dispersion. In this context, the tackifiers themselves are preferably in the form of an aqueous dispersion. The amount by weight of the tackifiers is preferably from 5 to 50 parts by weight, more preferably 10 to 30 parts by weight, relative to 100 parts by weight of polymer (solids/solids).

The adhesive composition may be composed solely of the polymer, or of the aqueous dispersion of the polymer, but may also further comprise the above-stated adjuvants, and also further adjuvants, examples being fillers, dyes, flow control agents, thickeners, preferably associative thickeners, defoamers, pigments or wetting agents. For improved surface wetting, the adhesive compositions may more particularly comprise wetting assistants, examples being fatty alcohol ethoxylates, alkylphenol ethoxylates, nonylphenol ethoxylates, polyoxyethylenes/-propylenes or sodium dodecylsulfonates. The amount of adjuvants is generally from 0.01 to 5 parts by weight, more particularly 0.1 to 3 parts by weight, per 100 parts by weight of polymer (solids).

The folding-carton blanks may be made of a material suitable for producing folding cartons. Examples of suitable materials include paperboard, cardboard, corrugated card or plastic. The surface may have paper stuck to it, may be laminated with films/foils, may be coated with plastic, may be printed with ink, primed or varnished. The surface of the blanks may be coated, for example, with PP, OPP, PVC, PE or with waxes. The thickness of the blank material is preferably from 0.5 to 10 mm.

Application of the adhesive composition to the folding-carton blanks may take place by means of customary application or coating methods, as for example using a size press, film press, blade coater, air brush, knife coater, a curtain-coating method or a spray coater. In one preferred embodiment, application takes place by means of a print application technology, e.g., flexographic, offset or screen printing. Flexographic printing is preferred. After the print-applied adhesive coating has dried, its blocking resistance is such that the printed flat folding-carton blanks can be stacked without adhering to one another. In particular the blocking-resistance of the print-applied adhesive is such that a stack of the flat blanks, generally cartons, that are printed with the adhesive can be stored under a weight of 2 t/m² for up to one year without individual cartons adhering to one another when separated.

In one embodiment, the adhesive composition is applied to the raw material intended for blanks but not yet cut to size, after which the blanks are produced, by punching or cutting, for example,

The blanks may have a complete or partial coating of the adhesive composition. The adhesive composition is preferably applied only in those, limited regions which are actually adhesively bonded. The amount applied (wet) is preferably from 10 to 300 g/m². The layer thickness of the applied and dried adhesive is preferably from 5 to 200 μm.

Folding cartons can be produced from the folding-carton blanks provided with the adhesive composition, using erecting machines that are known per se for that purpose, said machines having preferably been modified to include at least one installed microwave generator or to allow the irradiation of the blanks with an external microwave generator. Irradiation with microwaves can be accomplished before the areas intended for adhesive bonding are brought into contact with one another, or, preferably, while the areas are being brought into contact. Generally speaking, this is done with an applied pressure which is suitably high for a durable, firm bond. The time of radiative activation of the adhesive layer in the erecting machine is preferably less than 2 seconds, less than 1 second or less than 0.5 second. Within the activation time, the layer of adhesive becomes sufficiently tacky to effect secure adhesive bonding of the folding cartons in the erecting machine, if desired with subsequent or simultaneous application of an applied pressure. Adhesive bonding is considered sufficiently reliable if, in the case of adhesively bonded cartons, the adhesive bond can be parted only with complete fiber extraction.

In the case of adhesive bonding in the erecting machine, the layer of adhesive that is applied to a first region of the surface of the blank may be bonded either against a layer of adhesive applied to a second region of the surface of the blank, or against an adhesive-free region of the blank. At the site intended for adhesive bonding, the adhesive-free region may also be printed with ink, primed or varnished.

Activation of the layer of adhesive takes place preferably with electromagnetic radiation (microwave radiation) with a wavelength in the 1 mm to 1 m range, preferably from 5 mm to 0.5 m.

One preferred radiation source is a microwave concentrator, with which microwaves can be focused, locally concentrated for the site-specific treatment of a workpiece, and/or made useful for the excitation of plasmas. An arrangement for the concentration of microwave energy in a local sphere of action is described in DE 10 2006 034084, for example. Another device for generating microwaves for the treatment of workpieces is described in WO 00/75955. A portable microwave device for local applications is described in JP 08-019620.

In one embodiment of the invention, the packs are filled with the packaging contents before, immediately after or at the same time as the microwave-activated adhesive-bonding operation. It is particularly advantageous if the contents for packaging are heat-sensitive or radiation-sensitive and if a microwave concentrator is used as radiation source. Activation of adhesive can then take place within a very short time and in a locally, narrowly confined region, without detrimental effect on heat-sensitive or radiation-sensitive contents of the pack. Sensitive contents are, for example, chocolate, ice cream, fatty or waxy products, pharmaceuticals, cosmetics or similar products.

In one embodiment of the invention, the adhesive composition comprises
a) from 20% to 70%, preferably from 30% to 50%, by weight of at least one microwave-activatable polymer,
b) from 2% to 30%, preferably from 5% to 15%, by weight of at least one microwave-radiation absorber, and
c) from 5% to 40%, preferably from 10% to 35%, by weight of at least one plasticizer.

The use of microwave radiation for activation of adhesive has the advantage over use of other activation sources, such as IR lamps, for example, that the contents of the carton are not aggressively affected. In the case of activation by microwave radiation, the carton beneath the layer of adhesive heats up only relatively slightly. In order to activate the same adhesive to a sufficient degree by means of IR, it is necessary to irradiate IR radiation to an extent such that the carton beneath the adhesive can heat up to temperatures of 100° C. or more.

### Examples of Microwave-Activatable Adhesive Compositions

Abbreviations used are as follows:
MMA: Methyl methacrylate
S: Styrene
BA: Butyl acrylate
AA: Acrylic acid
MAA: Methacrylic acid
E: Ethylene
VAc: Vinyl acetate
aMS: alpha-Methylstyrene
Pluriol: Polyethylene glycol (plasticizer)

The Ig G′ values were measured as described above. Adhesive was applied at 20 g/m² (solids) to each of two strips of card, and then the two strips were placed against one another, adhesive layer against adhesive layer, under a pressure of 15 g/cm², and were activated by microwave in such a way as to produce a temperature of 120° C. in the adhesive layer for half a second. The adhesive bond was then left to cool to room temperature, after which the strength of the bond was assessed.

The adhesive-bonding properties were assessed by manually separating the mutually bonded cardboard test pieces at the site of adhesive bonding. “+” denotes difficult separation at the bonding site, with cardboard fiber extraction “−” denotes easy separation at the bonding site, without fiber extraction.

The blocking resistance was assessed by means of a test in which the cardboard coated with the adhesive and dried was stored against a second coated cardboard at 40° C. for 3 days under a weight of 2 g/mm². In this arrangement, the two layers of adhesive were placed against one another.

“+” denotes that, after storage, it was possible to separate the cards from one another without blocking.
“−” denotes adherence of the layers of adhesive to one another (blocking) after storage.

Polymers used are as follows (amounts in parts by weight):

| | MMA | S | BA | AA | MAA | E | VAc | aMS | Tg ° C. |
|---|---|---|---|---|---|---|---|---|---|
| Polymer 1 | 31 | 26 | 33 | — | 10 | — | — | — | 45 |
| Polymer 2 | 51 | 26 | 13 | 10 | — | — | — | — | 78 |
| Polymer 3 | 56 | 26 | 13 | 5 | — | — | — | — | 77 |
| Polymer 4 | — | 58 | — | — | 34 | — | — | 8 | 106 |
| Polymer 5 | — | — | — | — | 3 | 80 | 17 | — | 80 |

Comparative examples

| | | | | | | | | | |
|---|---|---|---|---|---|---|---|---|---|
| Polymer 6 | 10 | 52 | 28 | 10 | — | — | — | — | 50 |
| Polymer 7 | 10 | 40 | 40 | 10 | — | — | — | — | 25 |

Adhesive compositions in dispersion or solution in water (amounts in parts by weight):

| | Amount of | | | | | | |
|---|---|---|---|---|---|---|---|
| | polymer | Carbon | Pluriol ® | Ig G′ | Ig G′ | Adhesive | Blocking |
| Polymer | solids | black | E 200 | (25° C.) | (120° C.) | bonding | resistance |
| Polymer 1 | 70 | 5 | 30 | 6.2 | 3.2 | + | + |
| Polymer 2 | 70 | 10 | 30 | 7.1 | 3.7 | + | + |
| Polymer 3 | 70 | 10 | 30 | 6.8 | 3.4 | + | + |
| Polymer 4 | 90 | 10 | 10 | 7.2 | 2.3 | + | + |
| Polymer 5¹⁾ | 100 | 10 | — | 6.1 | 3.0 | + | + |

Comparative examples

| | | | | | | | |
|---|---|---|---|---|---|---|---|
| Polymer 5 | 80 | 10 | 20 | 7.2 | 4.1 | − | + |
| Polymer 4 | 100 | 10 | — | 6.2 | 4.2 | − | + |
| Polymer 6 | 90 | 10 | 10 | 5.2 | 3.0 | + | − |

¹⁾Contains 10 parts by weight of tackifier (partially esterified abietic acid)

Activation of the adhesive with microwave radiation leads to comparatively low heating of the cardboard, to only up to about 50° C., for sufficient activation of the adhesive. In the case of comparable activation by IR radiation, using IR lamps, in contrast, the cardboard heats up to at least 100° C. in order to ensure sufficient activation of the layer of adhesive.

1. The use of a microwave-activatable adhesive composition for producing folding-carton blanks for the microwave-activated production of folding cartons.

2. The use according to claim 1, wherein the adhesive composition at less than or equal to 25° C. has an Ig G′ value of greater than or equal to 6.0 and at greater than or equal to 120° C. has an Ig G′ value of less than or equal to 4.0 and comprises at least one polymer having a glass transition temperature of greater than 30° C., and where the folding-carton blanks with adhesive composition applied thereto are blocking-resistant at 25° C. prior to microwave activation.

3. The use according to either of the preceding claims, wherein the adhesive composition comprises at least one polymer selected from the group consisting of polyurethanes, vinyl acetate polymers, acrylate polymers, and methacrylate polymers.

4. The use according to any of the preceding claims, wherein the adhesive composition comprises at least one copolymer formed from at least one first monomer and from more than 3% and less than 40% by weight, based on the total amount of monomers, of at least one second monomer, which is different from the first monomer, the first monomer being selected from the group consisting of alkyl acrylates, alkyl methacrylates, and vinylaromatics, and the second monomer being selected from the group consisting of ethylenically unsaturated monomers having acid groups, hydroxyalkyl acrylates, and hydroxyalkyl methacrylates.

5. The use according to any of the preceding claims, wherein the adhesive composition further comprises at least one nonadhesive microwave-radiation absorber.

6. The use according to the preceding claim, wherein the microwave-radiation absorber is selected from the group consisting of carbon black, graphite, organic color pigments, and mixtures thereof.

7. The use according to any of the preceding claims, wherein the adhesive composition further comprises at least one plasticizer.

8. The use according to the preceding claim, wherein the plasticizer is a polyalkylene glycol.

9. The use according to any of the preceding claims, wherein the plasticizer is a polyethylene glycol.

10. The use according to any of the preceding claims, wherein the adhesive composition comprises
a) from 20% to 70% by weight of at least one microwave-activatable polymer,
b) from 2% to 30% by weight of at least one microwave-radiation absorber, and
c) from 5% to 35% by weight of at least one plasticizer.

11. The use according to any of the preceding claims, wherein the folding-carton blank has regions with a print-applied, microwave-activatable adhesive composition in a layer thickness of 5 to 200 μm.

12. The use according to any of the preceding claims, wherein the adhesive composition is applied to the folding-carton blank by flexographic, offset or screen printing.

13. The use according to any of the preceding claims, wherein the adhesive composition is activated in a period of less than 2 seconds by microwave radiation with a wavelength of 1 mm to 1 m.

14. The use according to any of the preceding claims, wherein the microwave activation takes place by means of a microwave concentrator.

15. A method for producing folding cartons, in which
(1) flat folding-carton blanks are provided,
(2) a microwave-activatable adhesive composition is applied to parts at least of the flat folding-carton blanks,
(3) the flat folding-carton blanks are erected to form a folding carton, and
(4) before, during or after the erection of the folding-carton blanks, the adhesive composition is activated by microwave radiation, and adhesive bonding of the folding cartons is effected.

16. The method according to any of the preceding method claims, wherein the adhesive composition at less than or equal to 25° C. has an Ig G′ value of greater than or equal to 6.0 and at greater than or equal to 120° C. has an Ig G′ value of less than or equal to 4.0, is blocking-resistant following application to the folding-carton blanks at 25° C. prior to microwave activation, and comprises at least one polymer which has a glass transition temperature of greater than 30° C.

17. The method according to any of the preceding method claims, wherein the adhesive composition comprises at least one polymer selected from the group consisting of polyurethanes, vinyl acetate polymers, acrylate polymers, and methacrylate polymers.

18. The method according to any of the preceding method claims, wherein the adhesive composition comprises at least one copolymer formed from at least one first monomer and from more than 3% and less than 40% by weight, based on the total amount of monomers, of at least one second monomer, which is different from the first monomer, the first monomer being selected from the group consisting of alkyl acrylates, alkyl methacrylates, and vinylaromatics, and the second monomer being selected from the group consisting of ethylenically unsaturated monomers having acid groups, hydroxyalkyl acrylates, and hydroxyalkyl methacrylates.

19. The method according to any of the preceding method claims, wherein the adhesive composition further comprises at least one nonadhesive microwave-radiation absorber.

20. The method according to any of the preceding method claims, wherein the adhesive composition comprises
a) from 20% to 70% by weight of at least one microwave-activatable polymer,
b) from 2% to 30% by weight of at least one microwave-radiation absorber, and
c) from 5% to 35% by weight of at least one plasticizer.

21. The method according to any of the preceding method claims, wherein the adhesive composition is print-applied to subregions at least of the folding-carton blanks, in a layer thickness of 5-200 μm.

22. The method according to any of the preceding method claims, wherein the activation takes place in a period of less than 2 seconds by microwave radiation with a wavelength of 1 mm to 1 m.

23. The method according to any of the preceding method claims, wherein the microwave activation takes place by means of a microwave concentrator.

24. The method according to any of the preceding method claims, wherein the folding cartons are filled with packaging contents prior to or immediately after the microwave activation.
